(19) United States
(12) Patent Application Publication
(10) Pub. No.: US 2007/0191292 A1
(43) Pub. Date: Aug. 16, 2007

(54) Antimycotic rhamnolipid compositions and related methods of use

(76) Inventors: N.R. Gandhi, River Hills, WI (US); Victoria Palmer Skebba, Cedarburg, WI (US); Jon Y. Takemoto, North Logan, UT (US); Mekki F. Bensaci, Logan, UT (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/351,572

(22) Filed: Feb. 10, 2006

(51) Int. Cl. A01N 43/04

(52) U.S. Cl. 514/28; 514/54

(57) ABSTRACT

Antimycotic compositions comprising a rhamnolipid component and related methods of use.

### FIELD OF THE INVENTION

This invention is related to antimycotic compositions and methods of preparation and use thereof. The inventive compositions of the present invention can comprise an antimycotic component, in combination with a rhamnolipid surfactant, displaying activity against a wide spectrum of yeast and fungi.

### BACKGROUND OF THE INVENTION

The term mycotic generally refers to fungi, mushrooms, puffballs, yeasts and molds. Some experts estimate that there are 1.5 million fungus species, of which approximately 100,000 have been identified. Fungi can be pathogenic to humans, plants and animals, especially those with compromised immune systems. Some molds, in particular, release mycotoxins that can result in poisoning or death. Fungi and fungal diseases also inflict serious damage to the agricultural industry. In fact, each year millions of dollars of agricultural crops, including fruits, vegetables, grain and other plants, are lost due to fungal damage or infection. Post-harvest fungal infections of fruits and vegetables cause premature decay and spoilage of such food commodities. Fungal infections and disease devastate flowers, trees and shrubs.

A wide range of chemical and biological agents are available to prevent and/or treat yeast and fungal infections. However, tolerance or resistance can be a significant problem for disease management. For instance, strategies to decrease resistance include limiting certain types of systemic fungicide compositions and/or rotating between or combining fungicides of different modes of action. However, such success has been limited. The emergence of pathogens resistant to current strategies and/or pathogens not currently treatable, has increased the need for efficient antimycotic agents.

Alternatively, broad-spectrum, or multi-site conventional antimycotics can be used, but typically with high active ingredient levels and/or high application rates (i.e. high application frequency and/or the required application volume of such fungicides). Countervailing concerns relate to potential environmental damage, including fresh water and food product contamination, and/or adverse effects on plants, animals and humans.

Thus, there has been an on-going search in the art to identify novel antimycotic (e.g., antifungal/fungicidal) compositions with broad, long-term activity. One such approach includes the use of naturally-derived compounds to minimize potential environmental impact. For example, the plant bacterium, Pseudomonas syringae pv.syringae, produces an array of antifungal and/or antimicrobial peptides as secondary metabolites, some of which have been characterized as the small cyclic lipodepsipeptides, known as the syringomycins (SRs). Such compounds contain a long, unbranched 3-hydroxy fatty acid with a positive charge and a hydrophilic cyclic ring of nine amino acids at the C terminus. Their molecular weight can range from about 1000 to about 1300. The most common is syringomycin E (SRE), which possesses a peptide lactone ring head, with three positive charges and one negative charge, and a 3-hydroxydodecanoic acid hydrocarbon tail. The small cyclic lipodepsipeptide group includes other syringomycins (e.g. syringomycin A₁ and G), the syringostatins (SSs), the syringotoxins (STs) and the pseudomycins (PSs).

These metabolites are fungicidal to a broad range of fungi, including yeast and human pathogens. For example, studies have shown that syringomycin E has inhibitory activity against fungi and yeast such as Botrytis cinerea, Geotrichum candidum and Rhodoturula pilimanae. Recent studies have focused on the antifungal mechanism of action of the cyclic lipodepsinonapeptides. (Hama, H., D. A. Young, J. A. Radding, D. Ma, J. Tang, S. D. Stock, and J. Y. Takemoto. 2000. Requirement of sphingolipid alpha-hydroxylation for fungicidal action of syringomycin E. FEBS Lett. 478:26-8.) For example, syringomycin E (SRE) was shown to form channels in phospholipid bilayers, and it is speculated that a similar mechanism occurs in the target fungal membrane. (Dalla Serra, M., I. Bernhart, P. Nordera, D. Di Giorgio, A. Ballio, and G. Menestrina. 1999. Conductive properties and gating of channels formed by syringopeptin 25A, a bioactive lipodepsipeptide from Pseudomonas syringae pv.syringae, in planar lipid membranes. Mol. Plant Microbe Interact. 12:401-9.) It has been demonstrated that channel formation may cause the influx of cations such as H⁺, K⁺ and Ca⁺², causing lysis, due to the colloid-osmotic shock provoked by the ion flux through the membrane pores. (Takemoto, J. Y. 1992. in Bacterial phytotoxin syringomycin and its interaction with host membranes. (Verma, D. S., ed), Molecular signals in plant-microbe communications.:247-260.)

Although the syringomycins may be useful in providing broad spectrum control of fungi, the fungicidally effective concentrations currently under investigation raise concerns about the environmental impact of and chronic low dose health effects on humans and animals. Indeed, regulatory approval of cyclic lipodepsipeptides at the concentrations/levels presently considered for widespread use in antimycotic compositions has heretofore been precluded due to the potential toxicity of the compounds to humans, animals, and vegetation.

### BREIF DESCRIPTION OF THE DRAWINGS

FIGS. 1A-B and 2 illustrate structures of several non-limiting, representative monorhamnolipid and dirhamnolipid compounds.

FIG. 3 provides two embodiments of a rhamnolipid component, designated R1 and R2 for the respective mono- and dirhamnolipid structures, which can be used in combination one with the other, as described in several of the followings examples.

FIG. 4 provides the structure of syringomycin E, an antimycotic component, utilized in certain compositions of the present invention.

FIG. 5A shows the structures of several pseudomycin compounds, where R is a lipophilic moiety. In pseudomycin compounds A, A′, B, B′, C, C′, R is as follows: Pseudomycin A R=3,4-dihydroxytetradecanoyl; Pseudomycin A′R=3,4-dihydroxypentadecanoate; Pseudomycin B R=3-hydroxytetradecanoyl; Pseudomycin B′R=3-hydroxydodecanoate; Pseudomycin C R=3,4-dihydroxyhexadecanoyl; and Pseudomycin C′R=3-hydroxyhexadecanoyl. Pseudomycin compounds A′ and B′ are provided in FIGS. 5B and 5C, respectively.

### SUMMARY OF THE INVENTION

In light of the foregoing, it is a primary objective of this invention to provide a wide range of antifungal and/or fungicidal compositions of the type described herein, and/or method(s) for the preparation and subsequent use thereof, including, but not limited to, use of one or more fungicidal components, such as a lipodepsipeptide component, in combination with one or more rhamnolipid components to enhance the antifungal activity and/or reduce the fungicidally effective concentration of such components, thereby overcoming various deficiencies and shortcomings of the prior art, including those outlined above.

It is an object of the present invention to provide, various compositions, formulations or preparations, including component(s) exhibiting increased antimycotic efficacy at reduced levels.

It is accordingly a related object of the present invention to provide various systems comprising an antimycotic component, such as a lipodepsipeptide component, in concentrations and at effective application rates that demonstrate, for instance, broad spectrum antifungal activity at industry and/or regulatory acceptable toxicity levels.

It is a further object of the present invention to provide a variety of environmentally safe and/or nontoxic antimycotic compositions for commercial, home and/or agricultural use, including soil treatment, seed treatment, crop/foliage treatment and/or post-harvest applications for the prevention and treatment of fungal and yeast infections.

It will be understood by those skilled in the art that one or more aspects of this invention can meet certain objectives, while one or more other aspects can meet certain other objectives. Each objective may not apply equally, in all its respects, to every aspect of this invention. As such, these and other objects can be viewed in the alternative with respect to any one aspect of this invention.

Other objects, features, benefits and advantages of the present invention will be apparent from this summary, and the following descriptions of certain embodiments, and will be readily apparent to those skilled in the art having knowledge of fungicide compositions, biosurfactants and their use in the prevention and treatment of fungal infections. Such objects, features, benefits and advantages will be apparent from the above as taken into conjunction with the accompanying examples, data, figures and all reasonable inferences to be drawn therefrom.

In part, the present invention can comprise a composition comprising an antimycotic component selected from at least one syringomycin, at least one pseudomycin and combinations thereof; and a carrier component comprising a rhamnolipid. In certain embodiments, a rhamnolipid can be selected from a monorhamnolipid, a dirhamnolipid and combinations thereof. Such a rhamnolipid can be present in an amount sufficient to reduce the effective concentration of the antimycotic component to less than about 50% thereof. Likewise, in certain embodiments, regardless of rhamnolipid identity and/or amount, such a composition can comprise a syringomycin or, alternatively in certain other embodiments, a pseudomycin.

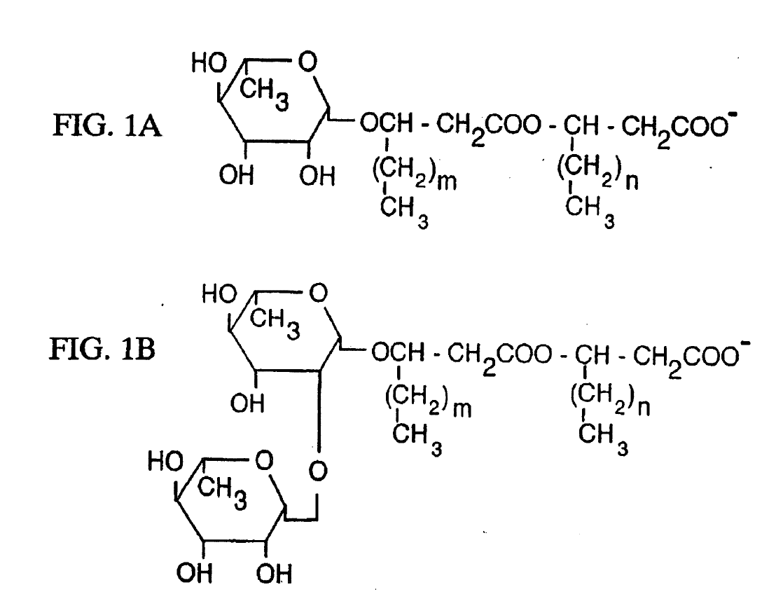

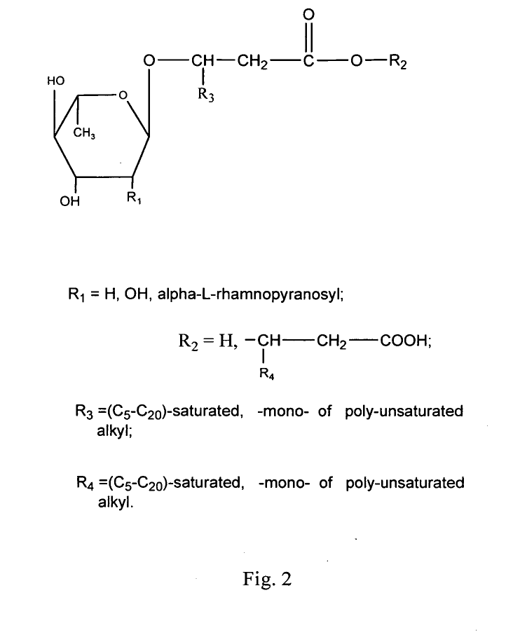

In accordance with this invention, as would be understood by those skilled in the art, a rhamnolipid can comprise one or more compounds of the sort described in U.S. Pat. Nos. 5,455,232 and 5,767,090, each of which is incorporated herein by reference in its entirety. Such a rhamnolipid compound, whether presently known in the art or hereafter isolated and/or characterized, can be of a structure disclosed therein or varied, as would also be understood by those skilled in the art. For example, without limitation, whether synthetically-derived or naturally occurring (e.g., from a Pseudomonas species or a strain thereof) in an acid form and/or as a corresponding acid salt, such a compound can be alkyl- and/or acyl-substituted (e.g., methyl and/or acetyl, respectively, and higher homologs thereof) at one or more of the saccharide hydroxy positions. Likewise, whether in mono- and/or dirhamno form, any such compound can be varied by hydrophobic moiety. As a non-limiting example, with reference to FIGS. 1A and 1B, m and n can independently range from about 4 to about 20, regardless of whether such moieties are saturated, monounsaturated or polyunsaturated, whether the hydrophobic moiety is protonated, present as the conjugate base with any counter ion or otherwise derivatized. Consistent with broader aspects of this invention, a rhamnolipid useful in such compositions is structurally limited only by resulting surface active function and/or antimycotic effect in conjunction with a syringomycin and/or a pseudomycin. Accordingly, structural variations of the sort described in International Publication WO 99/43334 are also considered in the context of this invention, such publication incorporated herein by reference in its entirety. See, also the non-limiting rhamnolipid components/structures of FIG. 2.

A syringomycin antimycotic component can comprise one or more syringomycin compounds, together with any salts or derivatives thereof, presently known in the art or hereafter isolated or characterized, including but not limited to one or more compounds demonstrating antifungal and/or fungicidal properties (e.g., syringomycins, syringostatins, and syringotoxins) described in U.S. Pat. Nos. 5,830,855 and 6,310,037, together with any reference cited therein, each of which is incorporated herein by reference in its entirety. While generally understood in the context of certain number(s) and/or order(s) of amino acid or modified amino acid residues, such compounds can vary by length and/or residue identity or sequence, limited only by natural, recombinant and/or mutant expression (e.g., by Pseudomonas syringae or strains thereof) or available synthetic technique. For instance, while certain such compounds can be characterized as having an N-terminal serine residue and a lactone moiety comprising the serine hydroxy and a C-terminal residue, various other lactone/cyclic peptide structures are contemplated, regardless of residue identity, number or sequence between the N- and C-terminals. Likewise, whether naturally-occurring or synthetically-derived, such components can vary by length, branching and/or degree of saturation of an N-terminal (e.g., N-acyl) substituent, as well as the position and/or degree of hydroxy substitution thereon. Without limitation, reference is made to the aforementioned, incorporated '855 patent and syringomycins A (SRA), E (SRE) and G (SRG) discussed therein. Consistent with a broader aspect of this invention, such syringomycin components are limited only by antimycotic effect, alone or in conjunction with a rhamnolipid of the sort described above.

A pseudomycin antimycotic component can comprise one or more pseudomycin compounds, together with any salts or derivatives thereof, presently known in the art or hereafter isolated or characterized, such compounds including but not limited to one or more compounds of the sort demonstrating antimycotic properties, as described in U.S. Pat. Nos. 6,919,188 and 6,793,925, together with the references cited therein, each of which is incorporated herein by reference in its entirety. While generally understood in the context of certain number(s) and/or order(s) of amino acid or modified amino acid residues, such compounds can vary by length and/or residue identity or sequence, limited only by natural, recombinant and/or mutant expression (e.g., by Pseudomonos syringae or strains thereof) or available synthetic techniques. For instance, while certain such compounds can be characterized as having an N-terminal serine residue and a lactone moiety comprising the serine hydroxy and a C-terminal residue, various other lactone/cyclic peptide structures are contemplated, regardless of residue identity, number or sequence between the N- and C-terminals. Likewise, whether naturally-occurring or synthetically-derived, such components can vary by length, branching and/or degree of saturation of an N-terminal (e.g., N-acyl) substituent, as well as the position and/or degree of hydroxy substitution thereon. Without limitation, reference is made to the aforementioned incorporated '188 patent and pseudomycins A, A′, B, B′, C and C′ discussed therein. Consistent with a broader aspect of this invention, such pseudomycin components are limited only by antimycotic effect, alone or in conjunction with a rhamnolipid of the sort described above.

While the present compositions can be described as comprising one or more components derived or isolated as a microbial fermentation product, it should be understood that this invention also contemplates the presence of one or more such components produced in situ, that is, biosynthesized on or in proximity to any area to be treated with such a composition. For instance, a rhamnolipid-producing and/or an antimycotic-producing organism can be grown, with the corresponding product(s) used as described herein to provide one or more of the inventive compositions. Such growth can be realized with or without a suitable culture or support medium, as would be understood by those skilled in the art made aware of this invention.

Without regard to antimycotic or rhamnolipid identity, a carrier component of the inventive compositions can comprise a fluid selected from, but not limited to, water, an alcohol, an oil, a gas and combinations thereof. For instance, while such compositions are unlimited with respect to amount of antimycotic or rhamnolipid quantities, a carrier comprising water and/or an alcohol can be used to facilitate desired formulation, shipping, storage and/or application properties, as well as effective concentration and resulting activity. Accordingly, various embodiments can also comprise a gaseous carrier component, such compositions as can be administered with a suitable propellant or as an aerosol.

In certain embodiments of this invention, such a composition can be on, or as can be applied to, a substrate or surface supporting or supportive of mycotic (e.g., yeast and/or fungi) growth. Accordingly, such a substrate or surface can comprise any material which can, is capable of or does support mycotic growth. Such substrates include but are not limited to wood, ceramics, porcelain, stone, plaster, drywall, cement, fabrics, leather, plastics and the like. Accordingly, such substrates can be selected from the available range of building materials/surfaces and consumer products.

In certain other embodiments, such a composition can be on, or as can be applied to, a substrate comprising a cellulosic component which can, is capable of or does support mycotic growth. Without limitation, certain embodiments can comprise plants, plant components (e.g., roots, stems, leaves, produce and the like) and any originating shoots or seeds. In particular, without limitation, such compositions can be on any plant produce, whether termed a fruit, vegetable, tuber, flower, seed or nut, whether before or post-harvest. Certain such plants and/or produce therefrom are recognized in the art, alone or collectively, as agricultural crops. Accordingly, in certain embodiments, a composition of this invention can be on or applied to such a crop at any time during development, pre-harvest and/or post-harvest.

In certain other embodiments, various compositions of this invention can be on, in contact with, or as applied or administered to a substrate or surface comprising mammalian or human tissue, including but not limited to nails, hair, skin and other cellular material, in the context of a pharmaceutical formulation for the treatment or prevention of yeast and fungal growth or infection. Representative compositions are described, below, in terms at least in part applicable to one or more other embodiments.

In part, the present invention can also be directed to a composition for inhibiting or preventing mycotic growth, such a composition comprising an antimycotic component of the sort described herein and a rhanmolipid surfactant component of the sort also described herein. Whereas each component, separately and individually, can have a certain antimycotic activity, a composition thereof can provide an enhanced antimycotic activity greater than any one component activity or the sum thereof. As demonstrated below, the rhamnolipid surfactant component can be in an amount at least partially sufficient to reduce the effective amount of the antimycotic component to less than about 50%, to maintain substantially the same or comparable level of activity. Regardless of rhamnolipid identity or amount thereof, such compositions can comprise a syringomycin and/or a pseudomycin antimycotic component. Likewise, such compositions can further comprise one or more other components to provide the composition multiple activities. For instance, such compositions can include but are not limited to antimicrobial, herbicidal and pesticidal components, as well as those others providing a range of biocidic activity.

Accordingly, as demonstrated below, the present invention can also comprise a method of using a rhamnolipid to improve antimycotic effect. Such a method can comprise providing an antimycotic component selected from a syringomycin, a pseudomycin and combinations thereof, such a component having a first inhibitory concentration for inhibition of mycotic growth; and contacting the antimycotic component and a rhamnolipid surfactant component, with the rhamnolipid component in an amount at least partially sufficient to improve antimycotic effect and the antimycotic component at a second inhibitory concentration less than the first inhibitory concentration. As such, an improvement can be quantitatively and/or qualitatively demonstrated by a zone of inhibition maintained or substantially unchanged at a lower concentration of antimycotic component. Various embodiments of such a methodology can comprise reducing the rhamnolipid component concentration, as desired, without substantial loss of antimycotic effect.

In the alternative, the present invention can be directed to a system comprising one or more of the present compositions on or in contact with a substrate comprising at least one of a yeast membrane and a fungal membrane. Such a composition can comprise a carrier component comprising a rhamnolipid in an amount at least partially sufficient to reduce the effective concentration of an antimycotic component with respect to the yeast or fungal membrane. In certain embodiments, the rhamnolipid component can be advantageously used in an amount sufficient to reduce the mammalian toxicity of the antimycotic component. In some such and certain other embodiments, the effective concentration of the antimycotic component can be reduced up to and/or greater than about 50%. Regardless of rhamnolipid identity, the yeast and/or fungal membranes of such a system can be on or in contact with a substrate selected from building surfaces and consumer products and/or those substrates comprising a cellulose component.

Regardless of the presence of mycotic organisms at any point in time, the present invention can also provide a method of inhibiting mycotic growth. Such a method can comprise providing a composition of the sort described herein, and contacting a substrate therewith. In certain embodiments, as described below, such a substrate can comprise a cellulosic component, such as but not limited to a plant or a seed. Contact can be through a growth medium such as soil or a hydroponic environment, an irrigation medium, and/or by way of a substrate surface coating, such as a film or residue on a seed. Alternatively, such a composition can be applied directly to a plant or its produce, whether pre- or post-harvest, to inhibit current and/or prospective growth.

### DETAILED DESCRIPTION OF CERTAIN EMBODIMENTS

With reference to the following examples, the present invention demonstrates that compositions comprising antimycotic components—in particular, lipodepsipeptide components—and rhamnolipid biosurfactants can provide substantial reduction of the level of antimycotic component—as compared to the prior art—without sacrificing antimycotic (e.g., fungicidal) efficacy.

Without limitation to any particular theory or mode of operation, the increased activity and/or effect exhibited may be due at least in part to the surface active nature of the rhamnolipid component. In particular, a rhamnolipid biosurfactant may open and/or enhance pore formation in the plasma membrane of the host organism, increasing cell permeability and therefore susceptibility of the cell to the antimycotic component. Data provided herein support the ability of an antimycotic agent to reach its target and alter cell membrane function much more effectively in the presence of a rhamnolipid. As such, effective formulations can be achieved using lower concentration levels of either the antimycotic or rhamnolipid components.

This effect is observed in SRE-Rhamnolipid compositions, as demonstrated in Example 3, below. SRE-rhamnolipid combinations (SYRA) exhibited increased fungicidal activity against a strain of BY4741 at 2.4 mg/ml SRE and 2.6 mg/ml rhamnolipid, compared to the activity of SRE alone at a concentration of 2.4 mg/ml (see also, Tables 2 and 3). It is observed that addition of the rhamnolipid component increased the efficacy of the SRE, due in part, to access of the fungicide to the fungal cell membrane, suggesting SRE and rhamnolipid interact to enhance antifungal activity against BY4741.

Further, Table 3 indicates that the antifungal activities of SRE-rhamnolipid combinations (SYRA) are dependent on the ratio of SRE and rhamnolipids present in the SYRA. For example, activity observed at the lowest concentration level of fungicide and biosurfactant components (e.g. 2.4 mg/ml SRE and 2.6 mg/ml rhamnolipid, with an inhibitory zone of 21 mm) was greater than that observed for the highest concentration level antimycotic and biosurfactant components tested (e.g. 10.3 mg/ml SRE and 85 mg/ml rhamnolipid, 20.5 mm).

With reference to Examples 4 and 5, the formulations of the present invention can be used to reduce the effective dose and/or application rate of either component without substantially sacrificing efficacy. For example, as illustrated in Tables 7A through 7C, dilute formulations of SRE-rhamnolipid compositions of the present invention offer comparable or increased activity at lower concentrations of SRE. For example, at 75%, 5.3 mg/ml rhamnolipid and a SRE dilution of 25%, the antifungal activity against R.pilimanae at a concentration of 2.4 mg/ml SRE (29.5 mm) is substantially comparable to the antifungal activity at 5.6 mg/ml SRE (30 mm)—an approximately 50% reduction in antimycotic component concentration with substantially comparable efficacies.

As mentioned above, the present invention can be directed to a method for using a rhamnolipid to reduce the effective amount of an antimycotic component required to achieve a given level of inhibition or antimycotic activity. In certain embodiments, as illustrated in several of the following examples, the concentration of antimycotic component can be reduced to or below a regulatory and/or governmental acceptable and/or approved level of use. In particular, with reference to Examples 2 through 4, use of a rhamnolipid as described herein can reduce the amount of a syringomycin (e.g., SRE) component to concentrations less than about 4 μg/ml (a level considered substantially safe/nontoxic), without substantially compromising efficacy. Reducing the effective amount of antimycotic or biosurfactant component required for a given level of antifungal activity can provide a range of compositional formulations that leave less fungicide residue on the food product than conventional fungicides—resulting in lower production and application costs while meeting or exceeding regulatory environmental and toxicity standards.

The relative amounts or concentrations of antimycotic component and biosurfactant component in the fungicide compositions of the present invention can vary widely within effective ranges, as demonstrated in the examples that follow. The concentrations and/or fungicidal doses utilized are preferably selected to achieve an enhanced or increased activity over the individual components alone and/or to maximize the activity of the composition at the lowest effective component concentration(s). Accordingly, the weight ratios and/or concentrations yielding such enhanced activity depend not only on the specific antimycotic component and biosurfactant component utilized, but on the specific end-use application of the composition including, but not limited to, climate, soil composition, nature of the host and/or potential exposure to a particular yeast or fungus.

In addition, the compositions of the present invention can comprise additional chemical and/or biological, multi-site and/or single site antimycotic or antifungal agents, of a similar and/or different modes of action, as will be well known to those skilled in the art. Such agents can include, but are not limited to, potassium bicarbonate, silica, copper or sulfur-based compounds and/or botanical oils (e.g. neem oil). Further, such agents can include, but are not limited to azoles; polyenes, such as amphotericin B and nystatin; purine or pyrimidine nucleotide inhibitors, such as flucytosine; polyoxins, such as nikkomycins; other chitin inhibitors, elongation factor inhibitors, such as sordarin and analogs thereof; inhibitors of mitochondrial respiration, inhibitors of sterol biosynthesis and/or any fungicidal composition known to those skilled in the art suitable for treating or preventing yeast or fungal infections of plants, animals and/or humans.

In certain embodiments, the compositions of the present invention can also include one or more preservative components, including but not limited to, sorbic or benzoic acid; the sodium, potassium, calcium and ammonium salts of benzoic, sorbic, hydroxymethyl glycinic, and propionic acid; and methyl, ethyl, propyl and butyl paraben and combinations thereof.

The compositions of the present invention can be used as aqueous dispersions or emulsions and are available in the form of a concentrate containing a high proportion of the antimycotic-biosurfactant system, as can be diluted (e.g., water or another fluid component) before use. These concentrates should preferably be able to withstand storage for prolonged periods and after such storage be capable of dilution with water in order to form aqueous preparations which remain homogeneous for a sufficient time to enable them to be applied by conventional spray equipment.

Depending on the type of end-use application, the compositions of the present invention may also comprise any other required components including, but not limited to, solid or liquid carriers to facilitate application, surfactants, protective colloids, adhesives, thickeners, thixotropic agents, penetrating agents, stabilizers, sequestrants, texturing agents, flavoring agents (for post-harvest applications), sugars, colorants, etc., as will be well known to those skilled in the art.

For example, the compositions can be used for agricultural purposes and formulated with such a carrier or diluent. The compositions can be applied, formulated or unformulated, directly to the foliage of a plant, to seeds or to other medium in which plants are growing or are to be planted, or they can be sprayed on, dusted on or applied as a cream or paste formulation, or they can be applied as a vapor or as slow release granules. Application can be to any part of the plant including the foliage, stems, branches or roots, or to soil surrounding the roots, or to the seed before it is planted, or to the soil generally, to irrigation water or to hydroponic culture systems. The inventive compositions can also be injected into plants or sprayed onto vegetation using electrodynamic spraying techniques or other low volume methods.

In certain embodiments, the compositions may be in the form of dustable powders or granules comprising a solid diluent or carrier, for example, fillers such as kaolin, bentonite, kieselguhr, dolomite, calcium carbonate, talc, powdered magnesia, fuller 's earth, gypsum, diatomaceous earth and china clay. Such granules can be preformed granules suitable for application to the soil without further treatment. These granules can be made either by impregnating pellets of filler with the active ingredient or by pelleting a mixture of the active ingredient and powdered filler. Compositions for dressing seed may include an agent (for example, a mineral oil) for assisting the adhesion of the composition to the seed; alternatively the active ingredient can be formulated for seed dressing purposes using an organic solvent. The compositions may also be in the form of wettable powders or water dispersible granules comprising wetting or dispersing agents to facilitate the dispersion in liquids. The powders and granules may also contain fillers and suspending agents. Alternatively, the compositions may be used in a micro-encapsulated form. They may also be formulated in biodegradable polymeric formulations to obtain a slow, controlled release of the active substance.

Regardless, such solid formulations can comprise a range of forms and shapes, including but not limited to cylinders, rods, blocks, capsules, tablets, pills, pellets, strips, spikes and the like. Alternatively, granulated or powdered material can be pressed into tablets or used to fill a range of capsules or shells. Regardless, such formulations can be used to introduce the present compositions into a soil or related growth medium, in the vicinity of approximate to the roots of a plant. In such embodiments, whether compositionally comprising a powder, dust, or granule, such compositions can be inserted into the soil in the form of spikes, rods, or other shaped moldings.

Emulsifiable concentrates or emulsions may be prepared by dissolving the active ingredients of the present invention in an organic solvent optionally containing a wetting or emulsifying agent and then adding the mixture to water which may also contain a wetting or emulsifying agent. Suitable organic solvents are aromatic solvents such as alkylbenzenes and alkylnaphthalenes, ketones such as cyclohexanone and methylcyclohexanone, chlorinated hydrocarbons such as chlorobenzene and trichlorethane, and alcohols such as benzyl alcohol, furfuryl alcohol, butanol and glycol ethers. Compositions to be used as sprays may be in the form of aerosols wherein the formulation is held in a container under pressure of a propellant, e.g. fluorotrichloromethane or dichlorodifluoromethane.

As mentioned above, certain compositions and methods of this invention can find utility in the pharmaceutical context. Accordingly, the antimycotic and rhamnolipid components of this invention contain one or more acidic or basic functional groups and are, thus, capable of forming salts and pharmaceutically-acceptable salts with pharmaceutically-acceptable acids and bases. The term “pharmaceutically-acceptable salts” refers to the relatively non-toxic, inorganic and organic acid and base addition salts of such compounds. Such salts can be prepared by reacting the component compound with a suitable acid or base. Suitable bases include the hydroxide, carbonate or bicarbonate of a pharmaceutically-acceptable metal cation, ammonia, or a pharmaceutically-acceptable organic primary, secondary or tertiary amine. Representative alkali or alkaline earth salts include the lithium, sodium, potassium, calcium, magnesium, and aluminum salts and the like. Representative organic amines useful for the formation of base addition salts include ethylamine, diethylamine, ethylenediamine, ethanolamine, diethanolamine, piperazine and the like. Representative acid addition salts include the hydrobromide, hydrochloride, sulfate, phosphate, nitrate, acetate, valerate, oleate, palmitate, stearate, laurate, benzoate, lactate, phosphate, tosylate, citrate, maleate, fumarate, succinate, tartrate, napthalate, mesylate, glucoheptonate, lactobionate, and laurylsulphonate salts and the like.

As mentioned above, the components, compositions and the pharmaceutically-acceptable salts of this invention, are antimycotic inhibitors. Tests, methods and assays for yeast and fungal inhibition are well known in the art. Thus, a yeast or fungus can be inhibited by contacting the growth with an effective amount of an inventive composition or by contacting a substrate/surface supportive of such growth with an effective amount of such a composition. The contacting may take place in vitro or in vivo. “Contacting” means that an antimycotic composition and the substrate/surface are brought together so that the composition can interact with growth thereon or later developed. Amounts of a composition effective to inhibit mycotic growth may be determined empirically, and making such determinations is within the skill in the art. Inhibition includes both reduction and elimination of yeast or fungal growth.

To treat an animal or human subject having a mycotic growth or suffering from infection, an effective amount of one or more of the present compositions, optionally including one or more pharmaceutically-acceptable component salts, can be administered as would be understood in the art. Effective dosage forms, modes of administration and dosage amounts may be determined empirically, and making such determinations is within the skill of the art. It is understood by those skilled in the art that the dosage amount will vary with the activity of the particular compound employed, the severity of the infection, the route of administration, the rate of excretion of the compound, the duration of the treatment, the identity of any other drugs being administered to the animal/subject, the age, size and species of the animal/subject, and like factors well known in the medical and veterinary arts. In general, a suitable daily dose will be that amount which is the lowest dose effective to produce a therapeutic effect. The total daily dosage will be determined by an attending physician or veterinarian within the scope of sound medical judgment. If desired, the effective daily dose of such a composition may be administered as two, three, four, five, six or more sub-doses, administered separately at appropriate intervals throughout the day. Animals treatable according to the invention include mammals. Mammals treatable according to the invention include dogs, cats, other domestic animals, and humans.

Compositions of this invention may be administered to an animal/patient for therapy by any suitable route of administration, including orally, nasally, rectally, intravaginally, parenterally, intracisternally and topically, as by powders, ointments or drops, including buccally and sublingually. The preferred routes of administration are orally and topically.

While it is possible for the active component(s) of such compositions to be administered individually or sequentially, it is preferable to administer the active ingredient(s) as a pharmaceutical formulation (composition). The compositions of the invention can comprise the active ingredient(s) in admixture with one or more pharmaceutically-acceptable carriers and, optionally, with one or more other compounds, drugs or other materials. Each carrier must be “acceptable” in the sense of being compatible with the other ingredients of the formulation and not injurious to the patient.

Regardless of the route of administration selected, the active ingredient(s) are formulated into pharmaceutically-acceptable dosage forms by conventional methods known to those of skill in the art. The amount of the active ingredient(s) or component(s) which will be combined with a carrier material to produce a single dosage form will vary depending upon the host being treated, the particular mode of administration and all of the other factors described above. The amount of the active ingredient(s) which will be combined with a carrier material to produce a single dosage form will generally be that amount of the active ingredient(s) which is the lowest dose effective to produce a therapeutic effect.

Methods of preparing pharmaceutical formulations or compositions include the step of bringing the component(s) into association with a carrier and, optionally, one or more accessory ingredients. In general, the formulations are prepared by uniformly and intimately bringing the active ingredient(s) into association with liquid carriers, or finely divided solid carriers, or both, and then, if necessary, shaping the product.

Formulations of the invention suitable for oral administration may be in the form of capsules, cachets, pills, tablets, lozenges (using a flavored base, usually sucrose and acacia or tragacanth), powders, granules, or as a solution or a suspension in an aqueous or nonaqueous liquid, or as an oil-in-water or water-in-oil liquid emulsion, or as an elixir or syrup, or as pastilles (using an inert base, such as gelatin and glycerin, or sucrose and acacia) and/or as mouth washes and the like, each containing a predetermined amount of the active ingredient(s). The active ingredient(s) or component(s) may also be administered as a bolus, electuary or paste.

In solid dosage forms of the invention for oral administration (capsules, tablets, pills, dragees, powders, granules and the like), the active ingredient(s) is/are mixed with one or more pharmaceutically-acceptable carriers, such as sodium citrate or dicalcium phosphate, and/or any of the following: (1) fillers or extenders, such as starches, lactose, sucrose, glucose, mannitol, and/or silicic acid; (2) binders, such as, for example, carboxymethyl-cellulose, alginates, gelatin, polyvinyl pyrrolidone, sucrose and/or acacia; (3) humectants, such as glycerol; (4) disintegrating agents, such as agar-agar, calcium carbonate, potato or tapioca starch, alginic acid, certain silicates, and sodium carbonate; (5) solution retarding agents, such as paraffin; (6) absorption accelerators, such as quaternary ammonium compounds; (7) wetting agents, such as, for example, cetyl alcohol and glycerol monostearate; (8) absorbents, such as kaolin and bentonite clay; (9) lubricants, such as talc, calcium stearate, magnesium stearate, solid polyethylene glycols, sodium lauryl sulfate, and mixtures thereof; and (10) coloring agents. In the case of capsules, tablets and pills, the pharmaceutical compositions may also comprise buffering agents. Solid compositions of a similar type may also be employed as fillers in soft and hard-filled gelatin capsules using such excipients as lactose or milk sugars, as well as high molecular weight polyethylene glycols and the like.

A tablet may be made by compression or molding, optionally with one or more accessory ingredients. Compressed tablets may be prepared using binder (for example, gelatin or hydroxypropylmethyl cellulose), lubricant, inert diluent, preservative, disintegrant (for example, sodium starch glycolate or cross-linked sodium carboxymethyl cellulose), surface-active or dispersing agent. Molded tablets may be made by molding in a suitable machine a mixture of the powdered active ingredient(s) moistened with an inert liquid diluent.

The tablets, and other solid dosage forms of the pharmaceutical compositions of the present invention, such as dragees, capsules, pills and granules, may optionally be scored or prepared with coatings and shells, such as enteric coatings and other coatings well known in the pharmaceutical-formulating art. They may also be formulated so as to provide slow or controlled release of the active ingredient(s) therein using, for example, hydroxypropylmethyl cellulose in varying proportions to provide the desired release profile, other polymer matrices, liposomes and/or microspheres. They may be sterilized by, for example, filtration through a bacteria-retaining filter. These compositions may also optionally contain opacifying agents and may be of a composition that they release the active ingredient(s) only, or preferentially, in a certain portion of the gastrointestinal tract, optionally, in a delayed manner. Examples of embedding compositions which can be used include polymeric substances and waxes. The active ingredient(s) can also be in microencapsulated form.

Liquid dosage forms for oral administration of the active ingredient(s) include pharmaceutically-acceptable emulsions, microemulsions, solutions, suspensions, syrups and elixirs. In addition to the active ingredient(s), the liquid dosage forms may contain inert diluents commonly used in the art, such as, for example, water or other solvents, solubilizing agents and emulsifiers, such as ethyl alcohol, isopropyl alcohol, ethyl carbonate, ethyl acetate, benzyl alcohol, benzyl benzoate, propylene glycol, 1,3-butylene glycol, oils (in particular, cottonseed, groundnut, corn, germ, olive, castor and sesame oils), glycerol, tetrahydrofuryl alcohol, polyethylene glycols and fatty acid esters of sorbitan, and mixtures thereof.

Besides inert diluents, the oral compositions can also include adjuvants such as wetting agents, emulsifying and suspending agents, sweetening, flavoring, coloring, perfuming and preservative agents. Suspensions, in addition to the active ingredient(s), may contain suspending agents as, for example, ethoxylated isostearyl alcohols, polyoxyethylene sorbitol and sorbitan esters, microcrystalline cellulose, aluminum metahydroxide, bentonite, agar-agar and tragacanth, and mixtures thereof.

Formulations of the pharmaceutical compositions of the invention for rectal or vaginal administration may be presented as a suppository, which may be prepared by mixing the active ingredient(s) with one or more suitable nonirritating excipients or carriers comprising, for example, cocoa butter, polyethylene glycol, a suppository wax or salicylate and which is solid at room temperature, but liquid at body temperature and, therefore, will melt in the rectum or vaginal cavity and release the active ingredient(s). Formulations of the present invention which are suitable for vaginal administration also include pessaries, tampons, creams, gels, pastes, foams or spray formulations containing such carriers as are known in the art to be appropriate.

Dosage forms for the topical or transdermal administration of the active ingredient(s) include powders, sprays, ointments, pastes, creams, lotions, gels, solutions, patches and inhalants. The active ingredient(s) may be mixed under sterile conditions with a pharmaceutically-acceptable carrier, and with any buffers, or propellants which may be required.

The ointments, pastes, creams and gels may contain, in addition to the active ingredient(s), excipients, such as animal and vegetable fats, oils, waxes, paraffins, starch, tragacanth, cellulose derivatives, polyethylene glycols, silicones, bentonites, silicic acid, talc and zinc oxide, or mixtures thereof. Powders and sprays can contain, in addition to the active ingredient(s), excipients such as lactose, talc, silicic acid, aluminum hydroxide, calcium silicates and polyamide powder, or mixtures of these substances. Sprays can additionally contain customary propellants such as chlorofluorohydrocarbons and volatile unsubstituted hydrocarbons, such as butane and propane.

Transdermal patches have the added advantage of providing controlled delivery of the active ingredient(s) to the body. Such dosage forms can be made by dissolving, dispersing or otherwise incorporating the active ingredient(s) in a proper medium, such as an elastomeric matrix material. Absorption enhancers can also be used to increase the flux of the active ingredient(s) across the skin. The rate of such flux can be controlled by either providing a rate-controlling membrane or dispersing the active ingredient(s) in a polymer matrix or gel.

Pharmaceutical compositions of this invention suitable for parenteral administration comprise the active ingredient(s) in combination with one or more pharmaceutically-acceptable sterile isotonic aqueous or nonaqueous solutions, dispersions, suspensions or emulsions, or sterile powders which may be reconstituted into sterile injectable solutions or dispersions just prior to use, which may contain antioxidants, buffers, solutes which render the formulation isotonic with the blood of the intended recipient or suspending or thickening agents.

Examples of suitable aqueous and nonaqueous carriers which may be employed in the pharmaceutical compositions of the invention include water, ethanol, polyols (such as glycerol, propylene glycol, polyethylene glycol, and the like), and suitable mixtures thereof, vegetable oils, such as olive oil, and injectable organic esters, such as ethyl oleate. Proper fluidity can be maintained, for example, by the use of coating materials, such as lecithin, by the maintenance of the required particle size in the case of dispersions, and by the use of surfactants.

These compositions may also contain adjuvants such as wetting agents, emulsifying agents and dispersing agents. It may also be desirable to include isotonic agents, such as sugars, sodium chloride, and the like in the compositions. In addition, prolonged absorption of the injectable pharmaceutical form may be brought about by the inclusion of agents which delay absorption such as aluminum monostearate and gelatin.

In some cases, in order to prolong the effect of the active ingredient(s), it is desirable to slow the absorption of the drug from subcutaneous or intramuscular injection. This may be accomplished by the use of a liquid suspension of crystalline or amorphous material having poor water solubility. The rate of absorption of the active ingredient(s) then depends upon its/their rate of dissolution which, in turn, may depend upon crystal size and crystalline form. Alternatively, delayed absorption of parenterally-administered active ingredient(s) is accomplished by dissolving or suspending the active ingredient(s) in an oil vehicle.

Injectable depot forms are made by forming microencapsule matrices of the active ingredient(s) in biodegradable polymers such as polylactide-polyglycolide. Depending on the ratio of the active ingredient(s) to polymer, and the nature of the particular polymer employed, the rate of release of the active ingredient(s) can be controlled. Examples of other biodegradable polymers include poly(orthoesters) and poly(anhydrides). Depot injectable formulations are also prepared by entrapping the active ingredient(s) in liposomes or microemulsions which are compatible with body tissue. The injectable materials can be sterilized for example, by filtration through a bacterial-retaining filter.

The formulations may be presented in unit-dose or multi-dose sealed containers, for example, ampoules and vials, and may be stored in a lyophilized condition requiring only the addition of the sterile liquid carrier, for example water for injection, immediately prior to use. Extemporaneous injection solutions and suspensions maybe prepared from sterile powders, granules and tablets of the type described above.

While part of the preceding discussion is provided in the context of pharmaceutical compositions, it will be understood by those skilled in the art that various aspects thereof are also applicable to compositions and methods directed to the growth, treatment and viability of plants and their produce. Accordingly, as would be understood by those in the art, such compositions can comprise and/or be applied in the form of pastes, gels, coatings on the surface of a plant or produce. Further, the compositions can comprise and/or be applied as a dust, powder or granule on any such plant or produce. Whether solid or semi-solid, such compositions an comprise and/or be applied using components known in the art to promote wetting or adhesion on such a plant or produce.

### EXAMPLES OF THE INVENTION

The following non-limiting examples and data illustrate various aspects and features relating to the compositions and methods of this invention. Such aspects and features include the surprising and unexpected results obtained using a range of antimycotic components with rhamnolipid biosurfactants in the preparation of the inventive compositions; in particular, such antimycotic-rhamnolipid combinations exhibit enhanced or increased activity at nontoxic and/or reduced levels/concentrations of the antimycotic component over use of such a component alone.

It should, of course, be understood that these examples are included for illustrative purpose only and that the invention is not limited to the particular combinations of materials, conditions, properties or the like set forth herein. Comparable utility and advantages can be realized using various other methodologies and/or compositional embodiments consistent with the scope of this invention.

All components and/or ingredients used in conjunction with the present invention are commercially available from sources well-known to those skilled in the art. Likewise, the various process parameters described herein can be readily modified by such individuals to account for variations in the identity or concentration of such components and ingredients or as required to achieve results in accordance with those described herein.

### Example 1

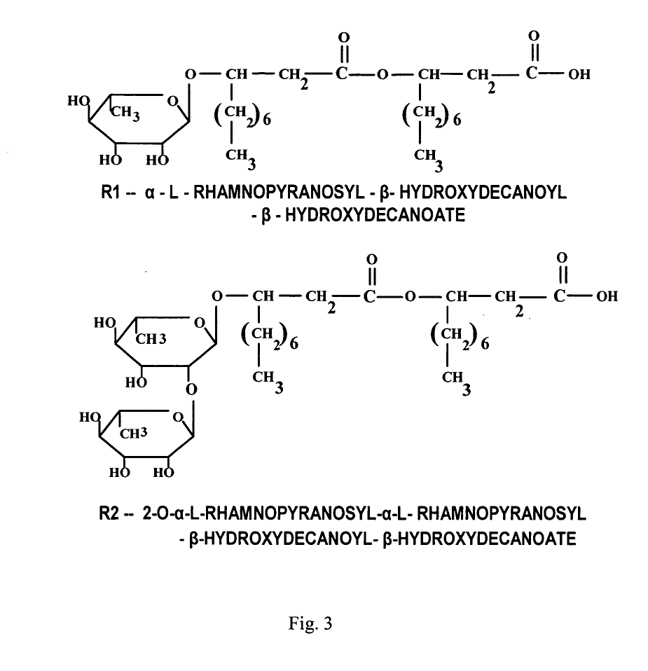

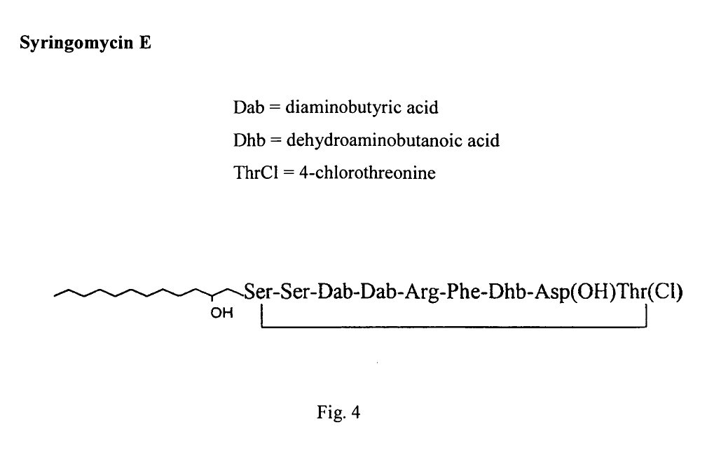

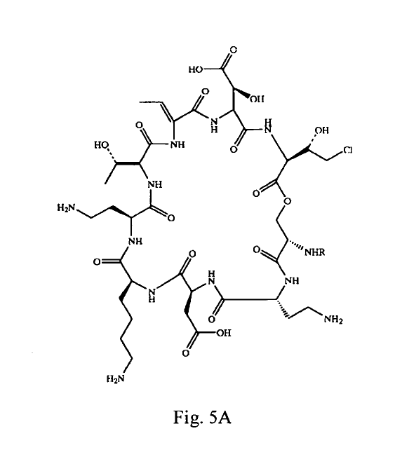

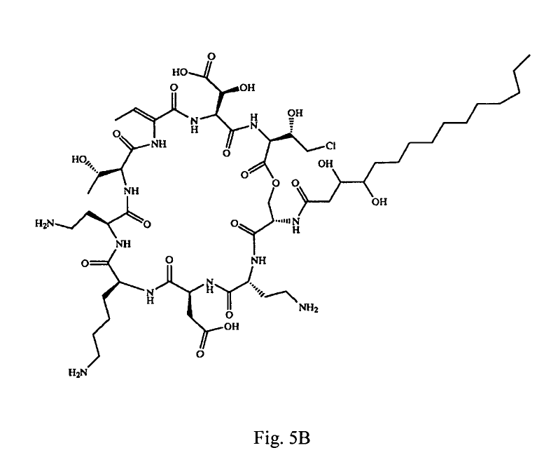

Rhamnolipids having the structures illustrated in FIG. 3 and sold under the trademark Zonix™ Biofungicide were obtained from Jeneil Biosurfactant Inc., Saukville, Wis. The stock solution of rhamnolipids contained approximately about 8.5% (by weight) rhamnolipid biosurfactant (85 mg/ml), composed of about 4.25% R1 and about 4.25% R2.

Syringomycin E, of the formula illustrated in FIG. 4, was purified from P.syringae pv.syringae strains B301D and M1, by the method of Bidwai et. al. (Bidwai. A. P., L. A., Robert C. Bachmann, and Jon Y. Takemoto. 1987. Mechanism of Action of Pseudomonas syringae phototoxin, syringomycin. Plant Physiol. 83:39-43.) Concentrations of SRE utilized included 10.3 mg/ml, 5.6 mg/ml and 2.4 mg/ml.

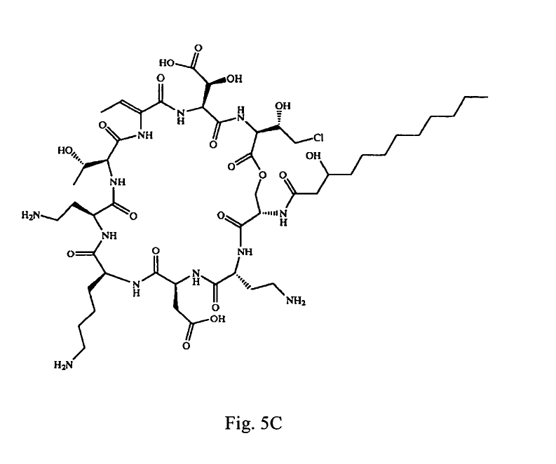

A range of pseudomycin components are available from Eli Lilly (Indianapolis, Ind.) or as described in the aforementioned '188 Patent, several representatives of which are provided in FIGS. 5A-C.

### Example 2A

Disk diffusion methods similar to those described by the NCCLS protocols for antifungal testing (Washington, G. L. W. a. J. A. 1995. Antibacterial Susceptibility Tests: Dilution and Disk Diffusion Methods, p. 1327-1341. in P. R. Murray (ed.), Manual of Clinical Microbiology, sixth ed.) were used. FIGS. 2(A) through 2(D) illustrate typically observed result assessments for antimicrobial combinations using the disk diffusion method.

Tested fungi, utilized in the examples that follow, were grown in RPMI Medium and adjusted to 5×10⁴ CFU/ml, and transferred onto solid agar medium of the appropriate growth medium. The cultures were spread over the surface as a thin film. Four millimeter-diameter sterilized paper disks were deposited on the surface and syringomycin E and rhamnolipids were applied on disk 1 and disk 2, respectively (in approximately about 7 to about 10 μl aliquots). The distance between the disks was equal to the sum of radii of zones of inhibition of the drugs applied alone. The plates were incubated at approximately 35° C. for approximately 24-72 h.

### Example 2B

The checkerboard method is used frequently to evaluate antimicrobial combinations in vitro (Lorian, V., M. D. 1996. Antibiotics in Laboratory Medicine, 4th ed.). The tests were easily performed at the laboratory level by using the microdilution method. The results obtained from this study provided a better understanding of the nature of the interaction between SRE and rhamnolipids.

The checkerboard method is described by Sabath et al. (Sabath, L. D. 1967. Synergy of antibacterial substances by apparently known mechanisms. Antimicrob. Agents Chemother. 7:210-7.) and Garrod et al. (Garrod L. P. and P. M. Waterworth. 1962. Methods of testing combined antibiotic bactericidal action and the significance of the results. J. Clin. Pathol. 15:328-38.). A 96-well plate was used to determine the fractional inhibitory concentrations (FICs). Serial twofold dilutions of SRE and rhamnolipids were prepared separately. Then 25 μl of different concentrations of syringomycin are added in a vertical orientation and the rhamnolipids were added in horizontal orientation. The final volume of the well contained 50 μl of the subject composition and 50 μl of the tested culture. The plate was incubated at 35° C. for 24-72 h. and the FICs were calculated using the equation: (A/MICa)+(B/MICb)=FICa+FICb=FIC index, where A and B are concentrations of SRE and rhamnolipids, MICa and MICb are the minimum inhibitory concentrations, and FICa and FICb are the fractional inhibitory concentrations of SRE and rhamnolipids, respectively.

### Example 3A

The antifungal activities of SRE and rhamnolipids were tested against a variety of yeast and fungi, as shown in Table 1. With two exceptions, rhamnolipids, alone, did not show activities against fungi and yeast tested. However, as illustrated in both Tables 1 and 2, SRE showed strong activity against these organisms.

SRE and Rh solutions were prepared, at the concentrations shown (mg/ml), then diluted and used to determine the minimum inhibitory concentration (MIC, μg/ml) of each, alone and in composition with the other (SYRA and SYRA2). With reference to Aspergillus flavus the SRE concentration was diluted 64-fold for a MIC observed at 7.8 μg/ml, but Rh provided no inhibition (NI) at the concentration shown. In contrast, in combination one with the other (SYRA), the MIC for Rh was observed at 5.85 μg/ml and for SRE at 3.9 μg/ml, upon dilution of the SYRA concentration (64-fold for SRE, and 128-fold for Rh). Comparing SRE values of 7.8 and 3.9 shows a 50% reduction in MIC using a rhamnolipid component of this invention. A more striking example of this invention is shown by comparison of MIC values for Rhodotorula pilminae, where use of rhamnolipid lowered the MIC for SRE from 3.9 to 0.97. Beneficial effects against the other organisms tested are evidenced by examination and analysis of the corresponding data.

TABLE 1
Antifungal MICs of SYRA

| | MIC (μg/ml) | | | |
|---|---|---|---|---|
| | | | SYRA | SYRA2 |
| | SRE | | SRE 0.25 mg/ml | SRE 0.75 mg/ml |
| | (0.5 mg/ml) | Rh (3 mg/ml) | Rh 0.75 mg/ml | Rh 0.25 mg/ml |
| Organism | MIC (μg/ml) | MIC (μg/ml) | MIC (μg/ml) | MIC (μg/ml) |
| ²*Aspergillus flavus | 7.8 | NI | Rh 5.85 | |
| | | | Sre 3.9 | |
| ¹*Rhodotorula pilimanae | 3.9 | 93.75 | Rh 2.92 | |
| | | | Sre 0.97 | |
| ²*Candida albicans | 3.9 | NI | Rh 5.85 | |
| | | | Sre 1.95 | |
| ¹*Rhizopus stonifer | 7.8 | NI | Rh 11.7 | |
| | | | Sre 3.9 | |
| ²*Fusarium oxysporum | 7.8 | NI | Rh 11.7 | |
| | | | Sre 3.9 | |
| ¹*Penicillium sp1 | 7.8 | NI | Rh 23.43 | Sre 5.85 |
| | | | Sre 7.8 | Rh 1.95 |
| ¹*Botrytis sp | 3.9 | 93.75 | Rh 2.92 | |
| | | | Sre 0.975 | |
| ¹*Rhizoctonia solani | 3.9 | NI | Rh 5.85 | |
| | | | Sre 1.95 | |
| ²*Cladosporium sp | 3.9 | NI | Rh 5.85 | |
| | | | Sre 1.95 | |
| ¹*Penicillium sp2 | 7.8 | NI | Rh 5.85 | |
| | | | Sre 1.95 | |

¹* and ²*values were obtained from three replicate.
For ¹* the results were the same in the three replicate.
For ²* the results were the same in the two first replicate. The third replicate the MICs were two fold lower than the MICs reported.
The microorganisms were incubated for 2 to 5 days at 28° C.

Of the concentrations of Syringomycin E (SRE) tested, the greatest fungicidal activity against any of the fungi tested was observed at the highest concentration, 10.3 mg/ml SRE, with fungicidal activity increasing as the concentration of SRE was increased from 2.4 mg/ml SRE to 10.3 mg/ml SRE, as shown in Table 2 below.

TABLE 2
Antifungal activity of SRE alone

| | | | | |
|---|---|---|---|---|
| SRE | BY4741 | W303C | 8A-1B | R.Pilimanae |

| | |
|---|---|
| (mg/ml) | Zone of Inhibition (mm) |

| | | | | |
|---|---|---|---|---|
| 10.3 | 23.0 | 29.0 | 20.0 | 23.0 |
| 5.6 | 21.0 | 28.0 | 19.0 | 21.5 |
| 2.4 | 19.0 | 26.0 | 17.5 | 19.0 |

### Example 3B

SYRA was obtained by mixing SRE and rhamnolipids at different relative concentrations. SYRA was tested against a variety of yeasts and fungi and the zone of inhibition was measured as described with reference to Examples 2A and 2B.

As shown in Table 3, SRE-rhamnolipid combinations (SYRA) exhibited increased fungicidal activity against BY4741 at 2.4 mg/ml SRE and 2.6 mg/ml rhamnolipid, compared to the activity of SRE alone at a concentration of 2.4 mg/ml (see also, Table 2), suggesting synergistic interaction of the SRE and rhamnolipid, resulting in enhanced fungicidal activity of the combination against BY4741.

Further, Table 3 indicates that the antifungal activities of SRE-rhamnolipid combinations (SYRA) are dependent on the ratio of SRE and rhamnolipids present in the SYRA. For example, fungicidal activity observed at the lowest concentration level of fungicide and biosurfactant components (e.g. 2.4 mg/ml SRE and 2.6 mg/ml rhamnolipid; 21 mm, zone of inhibition) was greater than that observed for the highest concentration level fungicide and biosurfactant components tested (e.g. 10.3 mg/ml SRE and 85 mg/ml rhamnolipid; 20.5 mm, zone of inhibition).

As shown, increasing the concentration of rhamnolipid at a given concentration of SRE does not correspondingly increase the inhibitory activity of the composition against the fungal pathogen. Indeed, fungicidal activity of SYRA was greatest at the lowest concentrations, e.g. 5.3 and 2.6 mg/ml, of Rhamnolipid component, for all concentrations of SRE indicated. In particular, as observed at the lowest concentration of SRE (2.4 mg/ml), activity of the SRE-Rh composition diminishes as the concentration of rhamnolipid increases, suggesting an optimal or maximum synergistic inhibitory effect can be achieved within certain concentration ranges of fungicide and biosurfactant component.

TABLE 3
Antifungal activity of SYRA Against BY4741

| | SRE (mg/ml) | | |
|---|---|---|---|
| | 10.3 | 5.6 | 2.4 |
| Rh (mg/ml) | Zone of Inhibition (mm) | | |
| 85.0 | 20.5 | 19.5 | 18.0 |
| 42.5 | 19.5 | 19.5 | 19.0 |
| 21.2 | 21.0 | 20.5 | 19.5 |
| 10.6 | 21.5 | 20.5 | 20.0 |
| 5.3 | 22.0 | 21.0 | 20.0 |
| 2.6 | 21.0 | 21.0 | 21.0 |

### Example 3C

As shown in Table 4, SRE-rhamnolipid combinations (SYRA) exhibited increased fungicidal activity against R. pilimanae at 2.4 mg/ml SRE and 2.6 mg/ml rhamnolipid, compared to the activity of SRE alone at a concentration of 2.4 mg/ml (see also, Table 2), suggesting synergistic interaction of the SRE and rhamnolipid, resulting in enhanced fungicidal activity of the combination against R.pilimanae.

Consistent with the results obtained for BY4741, increasing the concentration of rhamnolipid at a given concentration of SRE does not correspondingly increase the inhibitory activity of the composition against the fungal pathogen. Indeed, fungicidal activity of SYRA was greatest at the lowest concentrations, e.g. 5.3 and 2.6 mg/ml, of rhamnolipid component, for all concentrations of SRE indicated.

TABLE 4
Antifungal activity of SYRA Against R.pilimanae

| | SRE (mg/ml) | | |
|---|---|---|---|
| | 10.3 | 5.6 | 2.4 |
| Rh (mg/ml) | Zone of Inhibition (mm) | | |
| 85.0 | 27.0 | 24.5 | 22.5 |
| 42.5 | 26.0 | 24.0 | 22.0 |
| 21.2 | 24.0 | 23.0 | 22.0 |
| 10.6 | 25.0 | 24.0 | 20.0 |
| 5.3 | 28.0 | 27.0 | 25.0 |
| 2.6 | 26.0 | 24.0 | 21.0 |

### Example 3D

As illustrated in Table 5, the results indicate that the antifungal activities of SYRA are dependent on the ratio of SRE and rhamnolipids present in the SYRA. At 0.6 mg of SRE (and approximately 1.95 mg/ml of rhamnolipid in the SYRA), a synergistic effect was observed against all organisms tested.

TABLE 5
Antifungal activity of SYRA, by zone of inhibition (mm)

| SRE | Verticillium | Fusarium oxysporium | R.pilminae | Botrytis |
|---|---|---|---|---|
| 2.4 mg/ml* | 13 | 10 | 22 | 16 |
| 1.8 mg/ml* | 14 | 10 | 19 | 18 |
| 0.6 mg/ml* | 22 | 17 | 34 | 30 |
| RH (alone) | NI | NI | NI | 9 |

*concentration of SRE in SYRA applied to the disc

### Example 4A

SRE-rhamnolipid fungicidal activity was investigated against a strain of BY4741 at various concentrations and/or dilutions of SRE and rhamnolipid component.

As these results suggest, rhamnolipid can be used in combination with the fungicidally active SRE component to reduce the required application rate and/or required fungicidally effective dose of either component without substantially sacrificing efficacy. For example, the diluted formulations, including 75% rhamnolipid and 25% SRE as illustrated in Table 6B and 50% rhamnolipid and 50% SRE as illustrated in Table 6B, exhibit increased fungicidal activity versus the concentrated formulations, Table 6A.

In addition, dilute formulations offer comparable or increased fungicidal activity at lower concentrations of SRE. For example, at 75%, 5.3 mg/ml rhamnolipid and a SRE dilution of 25%, comparable antifungal activity is observed at 2.4 mg/ml SRE (26 mm, zone of inhibition) and 5.6 mg/ml SRE (29 mm, zone of inhibition)—an approximately 50% reduction in fungicide component at substantially comparable fungicidal efficacy. Reference is also made to Table 6C, where at 50%, 5.3 mg/ml rhamnolipid and a SRE dilution of 50%, comparable antifungal activity is observed at 2.4 mg/ml SRE (25 mm, zone of inhibition) and 5.6 mg/ml SRE (26 mm, zone of inhibition). These results suggest the ability to dramatically reduce the fungicidally effective amount of fungicide component required for a given level of fungicidal activity in synergistic formulations of antifungal and biosurfactant components.

TABLE 6A
Zones of Inhibition (mm)

| | | SRE (mg/ml) | | |
|---|---|---|---|---|
| | | 10.3 | 5.6 | 2.4 |
| Rh (mg/ml) | 85.0 | 20.5 | 19.5 | 18.0 |
| | 10.6 | 21.5 | 20.5 | 20.0 |
| | 5.3 | 22.0 | 21.0 | 20.0 |

TABLE 6B
Zones of Inhibition (mm)

| | | 25% of SRE (mg/ml) | | |
|---|---|---|---|---|
| | | 10.3 | 5.6 | 2.4 |
| 75% of Rh | 85.0 | 21.0 | 15.0 | NI |
| (mg/ml) | 10.6 | 29.0 | 28.0 | 27.0 |
| | 5.3 | 28.0 | 29.0 | 26.0 |

TABLE 6C
Zones of Inhibition (mm)

| | | 50% of SRE (mg/ml) | | |
|---|---|---|---|---|
| | | 10.3 | 5.6 | 2.4 |
| 50% of Rh | 85.0 | 23.0 | 22.5 | 15.0 |
| (mg/ml) | 10.6 | 29.0 | 27.0 | 27.0 |
| | 5.3 | 23.0 | 26.0 | 25.0 |

### Example 4B

SRE-rhamnolipid fungicidal activity was investigated against R.pilimanae at various concentrations and/or dilutions of SRE and rhamnolipid component.

Consistent with the results obtained with BY4741, dilute formulations offer comparable or increased fungicidal activity at lower concentrations of SRE. For example, at 75%, 5.3 mg/ml rhamnolipid and a SRE dilution of 25%, comparable antifungal activity is observed at 2.4 mg/ml SRE (29.5 mm, zone of inhibition) and 5.6 mg/ml SRE (30 mm, zone of inhibition)—an approximately 50% reduction in fungicide component at substantially comparable fungicidal efficacy.

TABLE 7A
Zones of Inhibition (mm)

| | | 75% of SRE (mg/ml) | | |
|---|---|---|---|---|
| | | 10.3 | 5.6 | 2.4 |
| 25% of Rh | 85.0 | 29.0 | 27.0 | 27.0 |
| (mg/ml) | 10.6 | 20.0 | 30.0 | 29.0 |
| | 5.3 | 20.0 | 21.0 | 20.0 |

TABLE 7B
Zones of Inhibition (mm)

| | | 25% of SRE (mg/ml) | | |
|---|---|---|---|---|
| | | 10.3 | 5.6 | 2.4 |
| 75% of Rh | 85.0 | 30.0 | 25.0 | 25.0 |
| (mg/ml) | 10.6 | 30.0 | 30.0 | 31.0 |
| | 5.3 | 29.0 | 30.0 | 29.5 |

TABLE 7C
Zones of Inhibition (mm)

| | | 50% of SRE (mg/ml) | | |
|---|---|---|---|---|
| | | 10.3 | 5.6 | 2.4 |
| 50% of Rh | 85.0 | 34.0 | 30.0 | 30.0 |
| (mg/ml) | 10.6 | 29.0 | 30.0 | 31.0 |
| | 5.3 | 25.0 | 35.0 | 25.0 |

### Example 4C

Tables 8A through 8C illustrate the activity of specific formulations and dilutions of SRE-Rhamnolipid compositions, where 100% of SRE @ 2.4 mg/ml and 100% of Rh @ 2.6 mg/ml.

TABLE 8A
Zone of Inhibition (mm)

| | Mucor | Aspergillus | Rhizopus |
|---|---|---|---|
| SRE | 12 | 11.5 | 11.5 |
| 75% SRE | < | 10.0 | 11.0 |
| 50% SRE | < | 10.0 | 11.0 |
| 25% SRE | < | 18.0 | 20.0 |

TABLE 8B
Zone of Inhibition (mm)

| | Candida | Penicillium | Cladosporium |
|---|---|---|---|
| SRE | 21 | 13 | 15 |
| 75% SRE | 21 | 17 | 13 |
| 25% SRE | 40 | > | NA |
| Rh | > | > | > |

TABLE 8C
Zone of Inhibition (mm)

| | Verticillium | Fusarium oxysporium | Botrytis |
|---|---|---|---|
| SRE | 13 | 10 | 16 |
| 75% SRE | 14 | 10 | 18 |
| 25% SRE | 22 | 17 | 30 |
| Rh | NI | NI | 9 |

### Example 5

To test the effect of pH on the SRE-Rhamnolipid combinations, disk diffusion as described with reference to Example 2A was used. Table 9 illustrates the effect of pH. The SRE-Rh compositions were most effective over a pH range of about 5- about 6.

TABLE 9
Effect of pH on SRE-Rhamnolipid activity against R.pilminae.

| | SRE | 75% SRE | 25% SRE |
|---|---|---|---|
| | Zone of Inhibition (mm) | | |
| pH 4 | 22.0 | 21.5 | 25.0 |
| pH 5 | 24.0 | 24.0 | 40.0 |
| pH 6 | 22.0 | 19.0 | 34.0 |
| pH 7 | 20.0 | 18.0 | 26.0 |

100% of SRE = 2.4 mg/ml;
100% of Rh = 2.6 mg/ml

### Example 6

To test the effect of temperature on the SRE-Rhamnolipid combinations, disk diffusion as described with reference to Example 2A was used. Samples were autoclaved at a temperature of 121° C. for the times indicated. Table 10 illustrates activity of the samples before and after autoclaving.

TABLE 10
Effect of Temperature on SRE-Rhamnolipid
activity against R.pilminae.

| | 15 minutes | 30 minutes | 45 minutes |
|---|---|---|---|
| | Zone of Inhibition (mm) | | |
| SRE-AU | 22 | 20 | NA |
| 25% SRE | NI | NI | NA |
| AU-B | | | |
| RH-AU | NI | NI | NA |
| 25% SRE- | 34 | 32 | NA |
| AU-S | | | |

AU = Autoclaved
R = Rhamnolipid
S = Syringomycin

### Example 7

To investigate the mechanism of action of SYRA, Saccharomyces cerevisiae sphingolipid and sterol biosynthetic mutants were used. Saccharomyces cerevisiae parent strains 8A-1B, W303, BY4741 and SRE resistant mutant strains Δsmr1,Δsyr2,Δipt1, Δelo2,Δelo3,Δfah1 were utilized, as described previously (Stock, S. D., H. Hama, J. A. Radding, D. A. Young, and J. Y. Takemoto. 2000. Syringomycin E inhibition of Saccharomyces cerevisiae: requirement for biosynthesis of sphingolipids with very-long-chain fatty acids and mannose- and phosphoinositol-containing head groups. Antimicrob. Agents Chemother. 44:1174-80.). For growth inhibition, a replica plate method was used (Hama, J., D. A. Young, J. A. Radding, D. Ma, J. Tang, S. D. Stock, and J. Y. Takemoto. 2000. Requirement of sphingolipid alpha-hydroxylation for fungicidal action of syringomycin E. FEBS Lett. 478:26-8). Fresh cells were replica plated onto yeast extract-peptone-dextrose (YPD) agar containing different concentrations of SYRA. Growth with and without SYRA addition were compared to determine relative sensitivity.

The growth inhibitory activity of SRE was less in the mutants as compared to the wild type, showing that sphingolipids and ergosterol may play roles in SRE action against yeast. Without limitation to any one theory or mode of operation, SYRA may interact with the fungi plasma membrane through a mechanism of action similar to SRE.

### Example 8

Simulating antimycotic effect, the activity of SYRA on cellular membranes was investigated using the method described by Della Serra et al. and Sorensen et al. (Dalla Serra, M., G. Fagiuoli, P. Nordera, I. Bernhart, C. Della Volpe, D. Di Giorgio, A. Ballio, and G. Menestrina. 1999. The interaction of lipodepsipeptide toxins from Pseudomonas syringae pv.syringae with biological and model membranes: a comparison of syringotoxin, syringomycin, and two syringopeptins. Mol. Plant Microbe Interact. 12:391-400; Sorensen, K. N., K. H. Kim, and J. Y. Takemoto. 1996. In vitro antifungal and fungicidal activities and erythrocyte toxicities of cyclic lipodepsinonapeptides produced by Pseudomonas syringae pv.syringae. Antimicrob. Agents Chemother. 40:2710-3.). Sheep erythrocytes were used to test SYRA activity. Percent lysis was calculated using the equation: % hemolysis=100(Ai-Af)/(Ai-Aw), where Ai and Af are the absorbance (A650) at the beginning and the end of the experiment, and Aw (A650) was obtained after hypotonic lysis with pure water.

Results for SRE, Rh and combinations at 50% SRE and 25% SRE are illustrated in FIG. 4 and show rhamnolipid enhanced lysis. Such results can be extended to show enhanced membrane activity and permeability of fungi and yeast cells to an antimycotic component in the presence of a rhamnolipid component. It is expected that the minimum inhibitory concentration of SYRA will be lower than SRE as a result of enhancing SRE antifungal activity by rhamnolipids.

### Example 9

The preceding examples are only representative. Comparable results are available over a range of compositional embodiments. For instance, such compositions can comprise between about 0.01 and about 99.99% (by weight of a composition) of an antimycotic component, whether a syringomycin, a pseudomycin or a combination thereof, and between about 99.99 and about 0.01% (by weight of a composition) of a rhamnolipid component.

### Example 10

As mentioned above, rhamnolipid is commercially available from Jeneil Biotech, Inc. over a range of concentrations. Such products can be modified, as needed. Representative of but one aspect of the compositions of this invention, an aqueous concentrate (e.g., 25 weight %) can be diluted with water or another fluid component, with an emulsifier as may be needed, to provide a 5% component which can, as needed, be diluted up to about 5 . . . about 20 . . . about 50 . . . about 75 . . . or about 100 or more times, prior to or with use in conjunction with an antimycotic component.

### Example 11

Any of the aforementioned rhamnolipid components can be used, as would be understood by those skilled in the art, in the formulation of a range of compositional embodiments. For instance, whether before or after introduction with an antimycotic component and any other additive, ingredient or active component, the rhamnolipid component can be mixed with suitable carrier component(s) to provide a corresponding solid, gel, liquid, or aerosol, for use on or with any substrate of the sort described herein.

### Example 12

The present compositions comprising a pseudomycin can be formulated as described in the aforementioned '925 Patent and in U.S. Pat. No. 6,630,147, each of which is incorporated herein by reference in its entirety. For instance, such compositions can be formulated as (a) gelatin capsules as described in formulation 1 of example 7, therein; (b) an aerosol as described in formulation 3 of example 7, therein; (c) tablets, as described in formulation 4 of example 7, therein; and (d) suspensions, as described in formulation 7 of example 7, therein. As would be understood by those skilled in the art, these and other such compositions/formulations (including others in the '925 and '147 Patents) can be modified as described herein to include a rhamnolipid component, an amount of which for any end use application can be determined in a straight-forward manner without any undue experimentation and/or to reduce or minimize pseudomycin content. Likewise, such compositions can be further modified to incorporate a syringomycin component, in addition to or as a substitute for the pseudomycin component.

### Example 13

Various other compositions of this invention can be formulated to comprise a pseudomycin, for application against a range of plant pathogenic fungi, including but not limited to those organisms described in U.S. Pat. No. 5,981,264, the entirety of which is incorporated herein by reference. For instance, such compositions can be formulated as would be understood by those skilled in the art, with an appropriate solvent, carrier and/or a rhamnolipid component of the sort described herein. As an extension of the trials described in the '264 patent, the present compositions are contacted with a plant or another cellulosic substrate to inhibit mycotic growth thereon or prevent future growth. As would be understood by those skilled in the art, such compositions/formulations can be modified as described herein to include a rhamnolipid component, in amount of which for any composition or end use application can be determined in a straight-forward manner without undue experimentation and/or to reduce or minimize pseudomycin content. Likewise, such compositions can be further modified to incorporate a syringomycin component, in addition to or as a substitute for the pseudomycin component.

### Example 14

Likewise, with reference to the aforementioned '264 patent, a range of compositions comprising a pseudomycin composition can be formulated using a rhamnolipid component, optionally together with an inert pharmaceutically-acceptable carrier. Such carriers and other compositional components can be of the sort described herein or otherwise evidenced in the most recent edition of Remington's Pharmaceutical Sciences, incorporated herein by reference in its entirety. Such compositions can be administered by any method known in the art, as evidenced by Remington's Pharmaceutical Sciences. Dosages are dependent upon the type of administration, calculated by methods known in the art, and can be administered to a human or animal subject as described elsewhere herein or would otherwise be known to those skilled in the art.

### Example 15

Representing other non-limiting embodiments, various compositions of this invention can be formulated using one or more pseudomycin components as described in prior PCT application PCT/US01/25724, filed Aug. 17, 2001 and published as International Publication No. WO 02/15696, on Feb. 28, 2002, and used in accordance with the present methodologies in the treatment or protection of plants challenged by the fungi and disease states listed in Example 1, thereof. The present compositions and methods can be used as would be understood by those skilled in the art, with reference to the present invention and the aforementioned publication (now U.S. application Ser. No. 10/343,199), the entirety of which is incorporated herein by reference. In particular, the present compositions and methods can be used to treat M. fijiensis and the Black Sigatoka disease of banana plants and plantains. Likewise, as would be understood by those skilled in the art, these and other such compositions and methods can be modified as described herein to include a rhamnolipid component, an amount of which for any composition or end use application can be determined in a straight-forward manner without undue experimentation and/or to reduce or minimize pseudomycin content. Likewise, such compositions can be further modified to incorporate a syringomycin component, in addition to or as a substitute for the pseudomycin component.

We claim:

1. A composition comprising an antimycotic component selected from at least one syringomycin, at least one pseudomycin and combinations thereof; and a carrier component comprising a rhamnolipid.

2. The composition of claim 1 wherein said rhamnolipid is in an amount sufficient to reduce the effective concentration of said antimycotic component to less than about 50% thereof.

3. The composition of claim 1, wherein said rhamnolipid is selected from a monorhamnolipid, a dirhamnolipid and combinations thereof.

4. The composition of claim 3 comprising a syringomycin.

5. The composition of claim 3 comprising a pseudomycin.

6. The composition of claim 1 wherein said carrier component comprises a fluid selected from water, an alcohol, an oil, a gas and combinations thereof.

7. The composition of claim 1 on a substrate supportive of mycotic growth.

8. The composition of claim 7 wherein said substrate is an agricultural crop.

9. The composition of claim 7 wherein said start rate is selected from building surfaces and consumer products.

10. A composition for inhibiting or preventing mycotic growth, said composition comprising an antimycotic component selected from a syringomycin, a pseudomycin and combinations thereof, said antimycotic component having an antimycotic activity; and a rhamnolipid surfactant component having another antimycotic activity, said composition providing an antimycotic activity greater than the sum of said component activities.

11. The composition of claim 10 wherein said rhamnolipid surfactant component is in an amount sufficient to reduce the effective amount of said antimycotic component to less than about 50% thereof.

12. The composition of claim 10 wherein said rhamnolipid component is selected from a monorhamnolipid, a dirhamnolipid and combinations thereof.

13. The composition of claim 10 wherein said antimycotic component comprises a syringomycin.

14. The composition of claim 10 wherein said antimycotic component compromises a pseudomycin.

15. A method of using a rhamnolipid to improve antimycotic effect, said method comprising:
providing an antimycotic component selected from a syringomycin, a pseudomycin and combinations thereof, said component having a first inhibitory concentration for mycotic growth inhibition; and
contacting said antimycotic component and a rhamnolipid surfactant component, said rhamnolipid component in an amount at least partially sufficient to improve effect of said antimycotic component, said antimycotic component at a second inhibitory concentration less than said first inhibitory concentration.

16. The method of claim 15 wherein the amount of said rhamnolipid component reduces the inhibitory concentration of said antimycotic component by at least about 50%.

17. The method of claim 16 wherein said rhamnolipid component concentration is reduced without substantial loss of antimycotic effect.

18. The method of claim 15 wherein said antimycotic component is a syringomycin.

19. The method of claim 15 wherein said antimycotic component is a pseudomycin.

20. A system comprising a substrate comprising at least one of a yeast membrane and a fungal membrane, and a composition thereon, said composition comprising an antimycotic component selected from a syringomycin, a pseudomycin and combinations thereof, and a carrier component comprising a rhamnolipid, said rhamnolipid in an amount at least partially sufficient to reduce the effective concentration of said antimycotic component on said mycotic membrane.

21. The system of claim 20 wherein said rhamnolipid is in an amount sufficient to reduce the mammalian toxicity of said antimycotic component.

22. The system of claim 21 wherein said rhamnolipid is in an amount sufficient to reduce the effective concentration of said antimycotic component by greater than about 50%.

23. The system of claim 20 wherein said carrier component is selected from a monorhamnolipid, a dirhamnolipid and combinations thereof.

24. The system of claim 20 wherein said membrane is on a substrate selected from building surfaces and consumer products.

25. The system of claim 20 wherein said membrane is on a substrate comprising cellulose.

26. A method of inhibiting mycotic growth, said method comprising:
providing a composition comprising an antimycotic component selected from a syringomycin, a pseudomycin and combinations thereof, and a rhamnolipid component; and
contacting a substrate with said composition.

27. The method of claim 26 wherein said substrate comprises cellulose.

28. The method of claim 26 wherein said substrate comprises a plant.

29. The method of claim 28 wherein said contact is through at least one of an irrigation medium, a growth medium and a substrate surface coating.

30. The method of claim 28 wherein said composition is applied to plant produce.

31. The method of claim 30 wherein said application is post-harvest of said produce.

32. The method of claim 26 wherein said composition comprises a fluid component selected from water, an alcohol, an oil, a fat, a wax, a gas and combinations thereof.

33. The method of claim 26 wherein said composition comprises a solid particulate.
